(19) United States
(12) Patent Application Publication
(10) Pub. No.: US 2007/0175891 A1
(43) Pub. Date: Aug. 2, 2007

(54) Cooking apparatus

(75) Inventor: Kazunori Maeda, Nara (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Kadoma-shi, Osaka (JP)

(21) Appl. No.: 10/598,506

(22) PCT Filed: Feb. 24, 2005
(86) PCT No.: PCT/JP05/03049

§ 371 Date: Oct. 30, 2006

(30) Foreign Application Priority Data
Mar. 5, 2004 (JP) 2004-062662

(51) Int. Cl. H05B 6/68

(52) U.S. Cl. 219/720

(57) ABSTRACT

The object of the invention is to improve the safety of a cooking apparatus, the efficiency of the door opening and shutting operation of the door opening and shutting part, and the quality of a cooked food. An opening and shutting door 4 includes a handle 5 for opening and shutting the door, and a door key 11 removably mounted on the door and including engaging portions 11a and 11b provided on two portions of the door key spaced a given distance from each other and projected toward the heating chamber side. In the interior of a cooking apparatus main body, there is provided a door hook 13 which, in the door shut state, is engaged with the engaging portions 11a and 11b inserted to thereby hold the door key 11. The door hook 13 includes door switches 14 and 16 which, when they are contacted with the engaging portions 11a and 11b, can be respectively switched so as to allow a power supply circuit for heating to conduct. The door key 11 has play in its connecting portion with the handle 5, while the play corresponds to the distance that the door key 11 moves in the longitudinal direction thereof when the opening and shutting door 4 is switched from its opened state to its shut state.

### TECHNICAL FIELD

The present invention relates to a heating apparatus such as a microwave oven and, specifically, the invention relates to the structure of a door opening and shutting part of a cooking apparatus.

### BACKGROUND ART

When using a microwave oven, an object to be cooked is placed within the microwave oven and, with the door of the oven shut, supply of microwaves is started. However, when the microwaves are supplied in a state where the door is not shut completely, for example, in a state where an engaging portion disposed on the upper portion of the door is locked to the main body side of the oven but an engaging portion disposed on the lower portion of the door is not locked, there is a fear that the microwaves can leak out of the oven. For this reason, normally, a microwave oven comprises a door opening and shutting part provided with a member for detecting that the door is completely shut and, only when the door is found completely shut, the oven is allowed to supply microwaves by driving a magnetron.

Now, description will be given below of the structure of a door opening and shutting part of a conventional cooking apparatus.

FIG. 16 is an explanatory section view of the structure of a first door opening and shutting part of a conventional cooking apparatus (for example, see the patent reference 1). As shown in FIG. 16, a conventional door opening and shutting part 110 is structured such that a door 111 includes a door key 112 and a main body of the apparatus (not shown) includes a door hook 116. Within the door hook 116, there are provided door switches 113, 114 and 115. The door switches 113, 114 and 115 are used to detect whether the door 111 is shut or not. When the door 111 is shut, a circuit, which is connected to a power supply part (not shown) for generating microwaves and a control part (not shown) for controlling the power supply part, is completed to allow the power supply part to operate; and, when the door 111 is opened, the connection of this circuit is cut off. The door key 112 includes, in the vicinity of the upper and lower ends thereof, engaging portions 112a and 112b which projects outwardly in such a manner that the lower edge portions thereof form an angle a with respect to the vertically downward direction of the door key 112; and, the door key 112 is held on the door 111 in such a manner that it can be moved in the vertical direction. The door hook 116 includes insertion openings 116a, 116b, into which the engaging portions 112a, 112b can be respectively inserted, and guide portions 117a, 117b for guiding the insertion operations of the engaging portions 112a, 112b. The door switches 113, 114 and 115 respectively include operation portions 113a, 114a and 115a which, when they are depressed, can bring their associated switches into conduction. The door switch 113 is disposed in the vicinity of the terminal end of the guide portion 117a, while door switches 114 and 115 are respectively disposed in the vicinity of the terminal end of the guide portion 117b; and, the door switch 114 is situated downwardly of the guide portion 117b, and the door switch 115 is situated upwardly of the door switch 114 while it is spaced from the door switch 114 by a distance corresponding to the thickness of the leading end portion of the engaging portion 112b.

When shutting the door 111, the engaging portions 112a and 112b of the door key 112 are respectively inserted from the insertion openings 116a and 116b of the door hook 116 along the guide portions 117a and 117b, and the lower side slanting surfaces of the respective engaging portions are contacted and engaged with the guide portions 117a and 117b. At the then time, the engaging portion 112a presses down the operation portion 113a of the door switch 113. On the other hand, the engaging portion 112b depresses the operation portion 114a of the door switch 114 and also depresses the operation portion 115a of the door switch 115.

When the door key 112 is held by the door hook 116 in this manner, the states of the door switches 113-115 are changed and thus the circuit connected to the power supply part and control part is allowed to conduct. Therefore, only when the door 111 is completely shut (when the upper and lower engaging portions of the door 111 are both locked to the main body side), the microwaves can be generated, which makes it possible to use the microwave oven in safety.

However, in the thus structured door opening and shutting part 110 of the cooking apparatus, because the engaging portions 112a and 112b of the door key 112 respectively form the angle a with respect to the vertical direction of the door key 112, in a state where the lower side slanting surfaces of the engaging portions 112a and 112b are contacted and engaged with the guide portions 117a and 117b, the engaging portions 112a and 112b are easy to shift in position. Owing to this, there is a possibility that the door opening and shutting part 110 can produce a clearance between the door 111 and apparatus main body.

FIG. 17 is an explanatory view of the structure of a second door opening and shutting part of a conventional cooking apparatus. Specifically, FIG. 17A shows the opened state of the door, whereas FIG. 17B shows the shut state of the door. As shown in FIG. 17, according to the conventional door opening and shutting part 120, in a door 128, there is provided a door key 122 which can be moved in the vertical direction in linking with a door pin 121 and a door knob, whereas in the main body (not shown), there are provided a short switch 123, a latch switch 124, a signal switch 125, and rotation portions 126, 127. The short switch 123, latch switch 124 and signal switch 125 are respectively used to detect whether the door 128 is shut or not, and they function similarly to the above-mentioned structure. The door pin 121 is fixedly secured to the door 128, whereas the door key 122 is rotatably mounted on the door 128. The short switch 123, latch switch 124 and signal switch 125 respectively include operation portions 123a, 124a and 125a which, when they are depressed, switch the on and off of their associated switches. A rotation portion 126, at a given position in a state where the door 128 is not shut, does not depress the operation portion 123a but turns off the short switch 123 and, when it is rotated counterclockwise from this position, it turns on the short switch 123. On the other hand, a rotation portion 127, at a given position in a state where the door is not shut, does not turn on the latch switch 124 and signal switch 125 but, when it is rotated clockwise from this position, it presses down the operation portions 124a and 125a to thereby turn on the latch switch 124 and signal switch 125.

When shutting the door, the door pin 121 pushes up the engaging portion 126a of the rotation portion 126 to rotate the rotation portion 126 counterclockwise, whereby the operation portion 123a, which has been depressed by the projecting portion 126b of the rotation portion 126, is switched over to a state in which it is not depressed. Also, when shutting the door, the door key 122 is rotated to push up the engaging portion 127a of the rotation portion 127, whereby the rotation portion 127 is rotated clockwise to remove the depressed states of the operation portions 124a and 125a.

When the door 128 is shut in this manner, the latch switch 124 and signal switch are turned on and, after then, the short switch 123 is turned off, so that the circuit connected to the power supply part and control part is allowed to conduct. Therefore, only when the door is shut completely, the microwaves can be generated.

However, in the door opening and shutting part 120, since the door pin 121 fixedly secured to the door 128 and the door key 122 rotatably mounted on the door 128 are operated by mutually different mechanisms, depending on the operation condition of the door knob, there is a possibility that the short switch 123 can vary in the on/off switching timing from the latch switch 124 and signal switch 125.

FIG. 18 is a section view of a third door opening and shutting part according to a conventional cooking apparatus, explaining the structure thereof (for example, see the patent reference 2.). As shown in FIG. 18, according to this conventional door opening and shutting part 130, on the door 131 side, there are provided a handle 132 projected from the door to the outside, two latch heads 133 and 134 respectively rotatably mounted on the upper and lower end portions of the handle 132, and a connecting lever 135 connecting together the latch heads 133 and 134 and movable in the vertical direction; and, on the main body side, there are provided door switches 136, 137 and 138, a rotation portion 139 rotatable in a direction where it is depressed, and two guide portions 139a and 139b, when the latch heads 133 and 134 are inserted into the main body, for guiding the insertion operations of the latch heads 133 and 134. The door switches 136-138 are respectively used to detect whether the door 131 is shut or not, and thus they function similarly to the previously mentioned switches. The door switch 136 is disposed upwardly of the terminal end portion of the guide portion 139a, and the door switch 137 is disposed downwardly of the terminal end portion of the guide portion 139a. Also, the door switch 138 is disposed downwardly of the terminal end portion of the guide portion 139b. The door switches 136-138 respectively include operation portions 136a-138a which, when they are depressed, change the states of their associated door switches. The rotation portion 139 of the main body, when it is depressed by the latch head 133, is rotated to press down the operation portion 136a of the door switch 136 to thereby turn on the door switch 136.

When shutting the door 131, the latch heads 133 and 134 are inserted along the guide portions 139a and 139b into the main body, while the lower sides of the latch heads 133 and 134 are contacted and thus engaged with the guide portions 139a and 139b respectively. At the then time, the latch head 133 presses down the rotation portion 139 to thereby allow the door switch 136 to press down the operation portion 136a, and the latch head 133 presses down the operation portion 137a of the door switch 137. On the other hand, the latch head 134 depresses the operation portion 138a of the door switch 138.

Thus, when the latch heads 133 and 134 are engaged with the guide portions 138a and 138b respectively, the states of the door switches 136-138 are changed, so that the circuit connected to the power supply part and control part is allowed to conduct.

However, according to the above-mentioned structure of the door opening and shutting part 130, because of a large number of rotation mechanisms such as the connecting portions between the handle 132 and latch heads 133, 134 and the rotation portion 139 of the main body, the turn-on timings of the switches are easy to vary.

FIG. 19 is a section view of a fourth door opening and shutting part according to a conventional cooking apparatus, explaining the structure thereof; and, specifically, FIG. 19A shows the opened state of a door and FIG. 19B shows the shut state of the door (for example, see the patent reference 3.). As shown in FIG. 19, this conventional door opening and shutting part 140 includes, on the main body side, two rotatable hook levers 142, 143, an operation button 141 which, when depressed from the outside, can press the engaging portion of the hook lever 142, and a door hook 145 which is fixedly secured to the main body side and with which a door key 144 can be engaged (which will be discussed below). The door key 144 can be moved in the vertical direction. Specifically, when shutting a door (not shown), the door key 144 moves in the downward direction and is thereby engaged with the door hook 145; and, when opening the door, the door key 144 moves upwardly and is thereby removed from the door hook 145.

When opening the door, the operation button 141, which is depressed from the outside, is pressed against the hook lever 142 to rotate it. The thus rotated hook lever 142 pushes up the hook lever 143 to rotate it. The thus rotated hook lever 143 pushes up the door key 144 to remove the door key 144 from the door hook 145. Also, when shutting the door, the door key 144 is pressed down and is engaged with the door hook 145. In this manner, by depressing the operation button 141, the door can be opened.

However, in the thus structured conventional door opening and shutting part 140, because the number of movable parts is large and the number of portions where the parts are contacted with each other is large, resistance between the parts is large. This requires a large operation force to open the door.

By the way, of the door opening and shutting parts of the above-mentioned conventional cooking apparatus, in the door opening and shutting part 110 shown in FIG. 16, the respective engaging portions 112a and 112b of the door key 112 are projected downwardly, while the operation portion 114a of the door switch 114 is disposed on the upper side of the door switch 114. Owing to this, as shown in FIG. 20, when foreign objects 118 such as meat soup and water drops stick to the door key 112, such foreign objects 118 stay in the leading end portion of the engaging portion 112b that projects downwardly. And, in this state, when the foreign objects 118 dry and the engaging portion 112b is operated while the dried foreign objects 118 are left stuck to the engaging portion 112b, there is a fear that the operation timing of the engaging portion 112b to depress the operation portion 114a of the door switch 114 can be shifted from the proper timing. Also, when the engaging portion 112b is operated before the foreign objects 118 dry, there is a fear that the foreign objects 118 can move from the leading end portion of the engaging portion 112b to the operation portion 114a of the door switch 114, resulting in the failure of the operation of the door switch 114. In other words, the downward projection of the engaging portions 112a and 112b makes it difficult to confirm the sticking of the foreign objects 118 and thus makes it difficult to clean the door opening and shutting part 110. Such problems can occur also in the door opening and shutting part 130 shown in FIG. 18, specifically, in the structure for combining the latch heads 133, 134 with the operation portions 137a, 138a of the door switches 137, 138.
Patent Reference 1: U.S. Pat. No. 6,333,495
Patent Reference 2: U.S. Pat. No. 4,542,269
Patent Reference 1: U.S. Pat. No. 5,857,720

### Disclosure of the Invention

### Problems that the Invention is to Solve

The present invention is made in view of the above circumstances found in the conventional door opening and shutting parts. Thus, it is an object to the invention to provide a door opening and shutting part of a cooking apparatus which can enhance the safety of the cooking apparatus, the efficiency of the door opening and shutting operation, and the quality of a cooked food.

### Means for Solving the Problems

A door opening and shutting part of a cooking apparatus according to the invention is a door opening and shutting part of a cooking apparatus which comprises: a cooking apparatus main body including a heating chamber; and, a door opening and shutting part for openably and closably locking the object-to-be-heated take-out opening of the heating chamber to thereby shut the take-out opening and for removing the locked state of the take-out opening to thereby open the take-out opening. Specifically, the door opening and shutting part comprises: a handle for opening and shutting an opening and shutting door; and, a door key disposed on the opening and shutting door so as to be movable in the longitudinal direction thereof in linking with the opening and shutting operation of the handle and including first and second engaging portions formed integrally with the door key, the first and second engaging portions being disposed in the two portions of the door key spaced a given distance from each other in the longitudinal direction of the door key and projecting toward the heating chamber. The cooking apparatus main body includes a door hook which can be engaged with the first and second engaging portions to be inserted into the cooking apparatus main body when the opening and shutting door is shut, thereby being able to hold the door key. The door hook includes first and second switches which, when the door hook is engaged with the first and second engaging portions, owing to the depressing operations of the first and second engaging portions, can be respectively switched so as to allow a power supply circuit for heating the heating chamber to conduct. In the present door opening and shutting part, there is set play in the connecting portion between the handle and the door key, while this play corresponds to the distance that the door key moves in the longitudinal direction thereof when the opening and shutting door is switched from its opened state to its shut state.

Thanks to this structure, with the operation of the handle, the first and second engaging portions can be operated simultaneously and, when shutting the opening and shutting door, the first and second door switches can be switched simultaneously. This not only can prevent generation of a time lag between the depressing operations to be executed by the first and second door switches but also can prevent the first and second door switches against the operation failures thereof. Although the door key moves when shutting the opening and shutting door, the play allows the door key to execute an idling operation, whereby the shutting operation of the opening and shutting door can be carried out while the handle remains held at the shut position. Therefore, the safety of the cooking apparatus can be enhanced without shutting the opening and shutting door incompletely and, at the same time, by opening and shutting the opening and shutting door using the handle, the opening and shutting operation of the opening and shutting door can be executed easily, thereby being able to enhance the efficiency of the door opening and shutting operation. And, the positive operation of the door switch can enhance the quality of a cooked hood.

Also, in a door opening and shutting part of a cooking apparatus according to the invention, the first and second engaging portions are disposed independently of each other in the upper and lower portions of the opening and shutting door. According to this structure, unless the first engaging portion disposed in the upper portion of the opening and shutting door and the second engaging portion disposed in the lower portion of the opening and shutting door are removed from the door hook simultaneously, the opening and shutting door cannot be opened. Thanks to this, even when only the first engaging portion or only the second engaging portion is removed from the door hook, the opening and shutting door cannot be opened, thereby being able to enhance the safety of the cooking apparatus.

Also, in a door opening and shutting part of a cooking apparatus according to the invention, the leading end portions of the first and second engaging portions project upwardly the leading end portions of the first and second engaging portions project upwardly. That is, since the leading end portions of the first and second engaging portions project upwardly, a foreign object such as meat soup or water drops is difficult to stick to the engaging portions.

Also, in a door opening and shutting part of a cooking apparatus according to the invention, the first and second door switches are disposed such that their respective pressing operation portions face downward. This structure can prevent a foreign object such as meat soup or other liquid soup from moving from the door key side over to the pressing operation portions and also can prevent a foreign object or dust from sticking to the pressing operation portions, whereby the first and second switches can be operated positively without causing the poor operations thereof.

Also, in a door opening and shutting part of a cooking apparatus according to the invention, the position of the first door switch relative to the first engaging portion is the same as the position of the second switch relative to the second engaging portion in the shut state of the opening and shutting door. According to this structure, because the first and second engaging portions can be operated simultaneously by operating the handle, and also because the position of the first door switch relative to the first engaging portion is the same as the position of the second switch relative to the second engaging portion in a state where the opening and shutting door shuts the object-to-be-heated take-out opening, when shutting the opening and shutting door, the first and second switches can be switched simultaneously. This makes it difficult for the opening and shutting door to be shut incompletely. This can enhance the safety of the cooking apparatus. Also, since the opening and shutting door can be opened and shut easily by opening and shutting it with the operation of the handle, the efficiency of the door opening and shutting operation can be enhanced.

And, in a door opening and shutting part of a cooking apparatus according to the invention, the door key includes, in the first and second engaging portions, portions which are parallel to the longitudinal direction of the door key, and the door hook, in the shut state of the opening and shutting door, brings the parallel portions into contact with the door hook to thereby hold the door key. Thanks to this structure, in the shut state, the door hook can hold the door key without generating a clearance between the first and second engaging portions. Also, since the door hook does not include a slanting surface like a conventional door hook and is not rotatable either, even when the pressure of the interior of the heating chamber rises suddenly, the door hook can be prevented from being opened. Further, because the door key has no angle, the resistance of the door key when it is engaged can be reduced, thereby being able to press the door switch positively. The opening and shutting door can prevent generation of a clearance between the cooking apparatus main body and itself and also can be prevented from opening easily, thereby being able to hold the object-to-be-heated take-out opening in a shut state.

Also, in a door opening and shutting part of a cooking apparatus according to the invention, the door hook includes, in the vicinity of the first door switch, a short switch which, when the first engaging portion is held, can be switched over so as to allow the power supply circuit to conduct, and the first engaging portion is disposed at a position where, when shutting the opening and shutting door, it depresses the first door switch after it presses down the short switch. This structure makes it possible to operate the power supply circuit more safely.

Further, in a door opening and shutting part of a cooking apparatus according to the invention, the handle is connected to the door key by a rack and pinion mechanism and, with the rotation operation of the handle, the door key can be operated in the vertical direction. Thanks to this structure, simply by changing the meshing engagement between the rack and pinion, the handle can be set at a desired position without changing the other remaining structures.

### Effects of the Invention

According to the invention, since the first and second door switches can be switched simultaneously and, even when the pressure of the interior of the heating chamber rises suddenly, the opening and shutting door can be prevented from opening, the safety of the cooking apparatus can be enhanced. Also, because the opening and shutting door can be opened and shut easily with a small force, the efficiency of the door opening and shutting operation can be enhanced. Further, since the door switches can be operated positively, the quality of the cooked food can be improved.

### BRIEF DESCRIPTION OF THE DRAWINGS

FIG. 1 It is an external view of the schematic structure of a high frequency wave cooking apparatus including a door opening and shutting part of a cooking apparatus, explaining a first embodiment of a door opening and shutting part according to the invention.

FIG. 2 It is a section view of the door opening and shutting part shown in FIG. 1, showing a state in which an opening and shutting door provided in the door opening and shutting part is shut.

FIG. 3 It is a section view of the door opening and shutting part shown in FIG. 1, showing a state in which the opening and shutting door of the door opening and shutting part is opened.

FIG. 4 It is an enlarged view of an engaging portion included in the door opening and shutting part shown in FIG. 1.

FIG. 5 It is a circuit diagram of an example of a power supply circuit employed in the door opening and shutting part shown in FIG. 1.

FIG. 6 It is a timing chart of switches when opening and shutting the opening and shutting door of the door opening and shutting part shown in FIG. 1.

FIG. 7 It is an enlarged section view of engaging portions and door switches. Specifically, FIG. 7A shows a state where no operation portions are depressed, FIG. 7B shows one of the operation portions is depressed, and FIG. 7C shows a state where both operation portions are depressed.

FIG. 8 It is a typical view of a mechanical structure employed in the door opening and shutting part shown in FIG. 1.

FIG. 9 It is a section view of another structure for connecting portions between a handle and a door key. Specifically, FIG. 9A shows a state where an opening and shutting door is opened, FIG. 9b shows a state where part of the door key is inserted into the main body side, and FIG. 9C shows a state where the opening and shutting door is shut.

FIG. 10 It is an external view of the schematic structure of a high frequency wave cooking apparatus including a door opening and shutting part of a cooking apparatus according to a second embodiment of the invention.

FIG. 11 It is a section view of the door opening and shutting part shown in FIG. 10.

FIG. 12 It is a partially broken external view of a handle and its peripheral portions in the door opening and shutting part shown in FIG. 10.

FIG. 13 It is an explanatory view of arrangement of a door key and a door switch according to another structure.

FIG. 14 It is a section view of a door opening and shutting part of a cooking apparatus according to a third embodiment of the invention, showing a state where an opening and shutting door is shut.

FIG. 15 It is a section view of a door opening and shutting part of a cooking apparatus according to a fourth embodiment of the invention, showing a state where an opening and shutting door is shut.

FIG. 16 It is an explanatory section view of the structure of a door opening and shutting part according to a first example of the prior art.

FIG. 17 It is an explanatory section view of the structure of a door opening and shutting part according to a second example of the prior art.

FIG. 18 It is an explanatory section view of the structure of a door opening and shutting part according to a third example of the prior art.

FIG. 19 It is an explanatory section view of the structure of a door opening and shutting part according to a fourth example of the prior art.

FIG. 20 It is a complementary explanatory view of a conventional structure.

### DESCRIPTION OF REFERENCE NUMERALS AND SIGNS

1: High frequency wave cooking apparatus
2: Main body case
3: Heating chamber
4, 50, 70, 80: Opening and shutting door
5, 51, 71: Handle
5a: Pinion
11, 52, 72: Doorkey
11a: Engaging portion (first engaging portion)
11b: Engaging portion (second engaging portion)
11c: Rack
12a, 12b: Insertion opening
13: Doorhook
13a, 13b: Guide portion
13c, 13d: Insertion opening
14: Door switch (first switch)
14a, 15a, 16a: Operation portion
15: Door switch (short switch)
16: Door switch (second switch)
54: Arm
56: Cut-out hole
83: Lower handle (handle)

### BEST MODE FOR CARRYING OUT THE INVENTION

Now, description will be given below of an example in which cooking apparatus door opening and shutting parts according to the embodiments of the invention are applied to a high frequency cooking apparatus with reference to the accompanying drawings.

Prior to explanation of a door opening and shutting part, firstly, description will be given below of the schematic structure of a high frequency wave cooking apparatus including this door opening and shutting part.

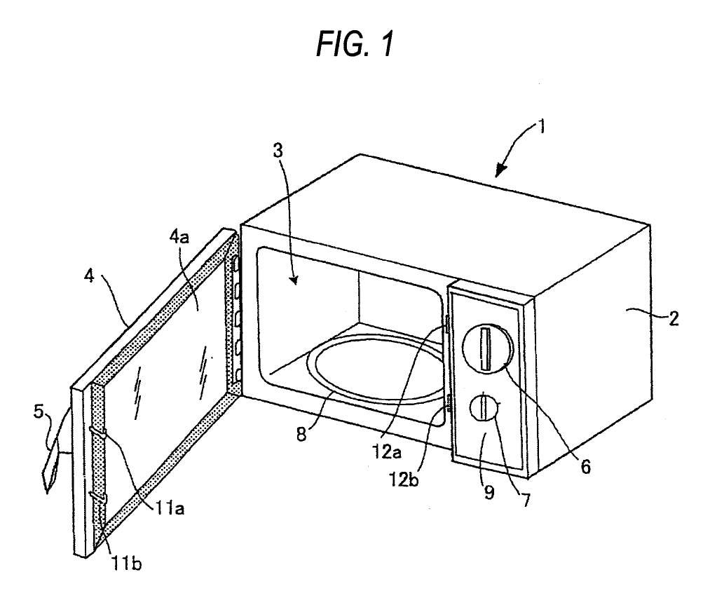

FIG. 1 is an external view of the schematic structure of a high frequency wave cooking apparatus including a door opening and shutting part of a cooking apparatus, explaining a first embodiment of a door opening and shutting part according to the invention. As shown in FIG. 1, a high frequency wave cooking apparatus (which is also hereinafter referred to as a cooking apparatus) 1 includes, in the interior of a main body case 2 which has a box-like shape and has its front surface opened, a heating chamber 3; on the front surface of the main body case 2, there is mounted an opening and shutting door 4 with a transparent window 4a which is used to open and shut the object-to-be-heated take-out opening of the heating chamber 3; and, on one side, namely, on the right side of the heating chamber 3, there is provided an operation panel 9. The left end of the opening and shutting door 4, which provides the other side of the heating chamber 3, is hinge connected to the left edge of the main body case 2, whereby the opening and shutting door 4 can be opened and shut in the right and left direction; and, when a handle 5 mounted substantially in the central portion of the right end portion of the opening and shutting door is pulled toward this side (obliquely upwardly), the door can be turned into its opened state. On the operation panel 9, there are mounted a timer 6 for setting a heating time and a knob 7 for switching the output of the apparatus over to, for example, 750W (for warming), 500W(for a frozen food) and 170W (for thawing of a frozen food).

In the high frequency wave cooking apparatus 1, after an object to be heated is placed on a turn table 8 and the opening and shutting door 4 is shut, when the output level is set using the knob 7 and the heating time is set using the timer 6, the magnetron (not shown) is driven and microwaves generated from the magnetron are supplied into the heating chamber 3.

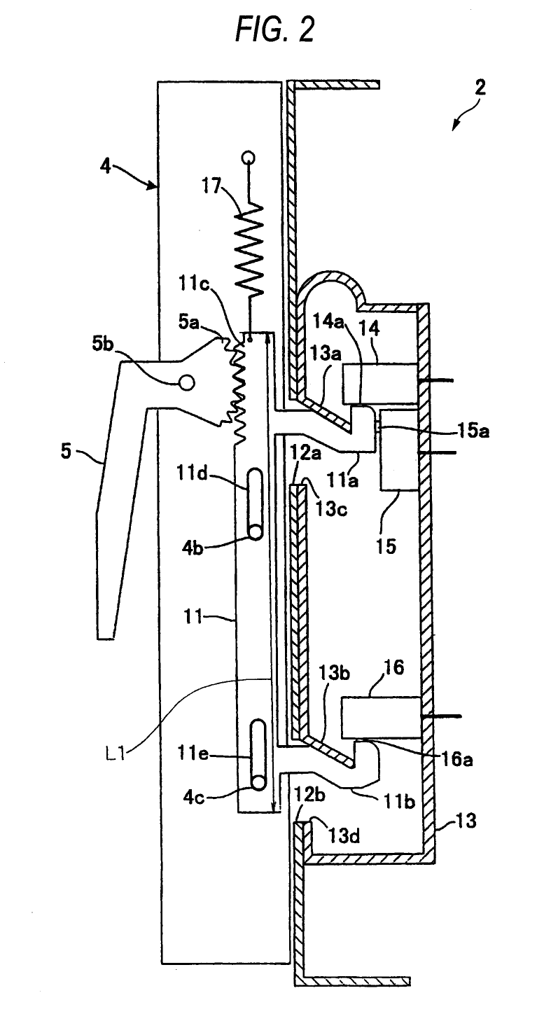

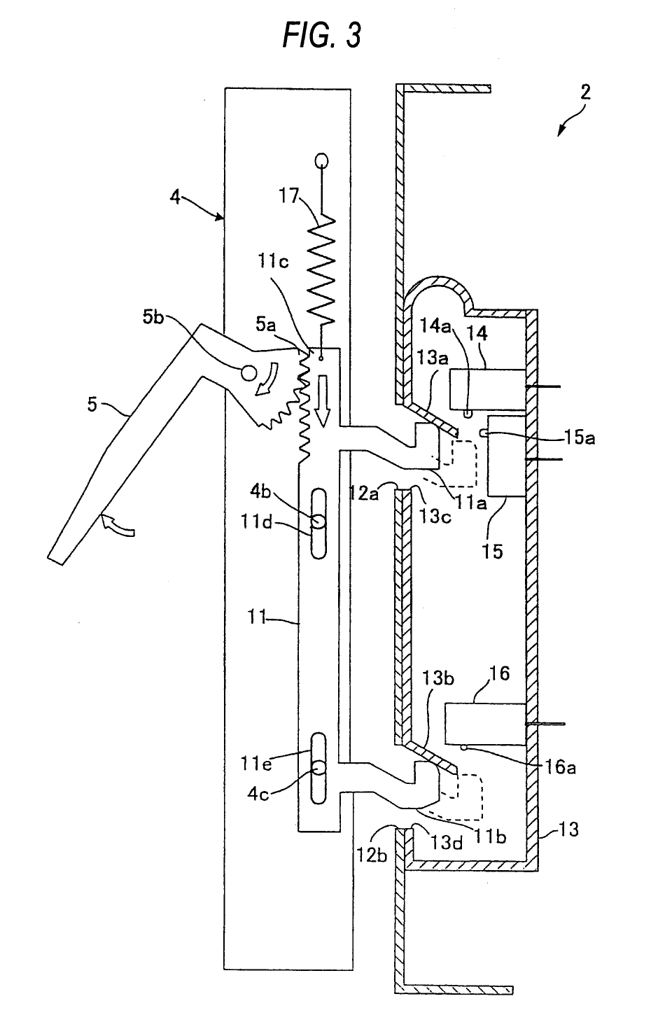

The opening and shutting door 4 includes a door key 11 (see FIGS. 2 and 3) in the interior of the right end portion thereof, while the engaging portions 11a and 11b of the door key 11 are respectively projected from the upper and lower portions of the door key toward the heating chamber 3. Also, the main body case 2 includes, on the right side of the object-to-be-heated take-out opening, insertion openings 12a and 12b into which the engaging portions 11a and 11b can be inserted when the opening and shutting door 4 is shut.

Next, description will be given below of the structure of the door opening and shutting part with reference to FIGS. 2 and 3. FIG. 2 is a section view of the door opening and shutting part, showing a state in which the opening and shutting door 4 is shut. FIG. 3 is a section view of the door opening and shutting part, showing a state in which the opening and shutting door 4 is opened. The door opening and shutting part is mainly composed of an opening and shutting door 4 and a door hook 13 which is provided within a main body case 2. The opening and shutting door 4 includes a handle 5 and a door key 11. The handle 5 is formed in a substantially L-like shape. One end of the handle 5 is projected downwardly into the outside of the opening and shutting door 4, whereas the other end of the handle 5 is stored in the interior of the opening and shutting door 4 and, on the end face of the other end of the handle 5, there is provided a pinion 5a. The door key 11 is a narrow and long member having a length L1. The door key 11 includes an engaging portion 11a at a position about L¼ from the upper end thereof and an engaging portion 11b at a position about L¼ from the lower end thereof. Also, the handle 5 is formed in a substantially L-like shape. One end of the handle 5 is extended downwardly outside the opening and shutting door 4, whereas the other end thereof is stored in the interior of the opening and shutting door 4. The other end has a power transmission structure composed of a rack, a pinion and the like, which allows the door 11 to move in the vertical direction. The door key 11 includes a narrow and long base portion and engaging portions 11a, 11b which are projected from the base portion and can be engaged with the main body case 2 side to lock the opening and shutting door 4 in a shut state. The engaging portions 11a and 11b are respectively formed so as to project upwardly. And, the engaging portions 11a and 11b are disposed on the upper and lower portions of the opening and shutting door 4 independently of each other. Thanks to this structure, unless the engaging portion 11a disposed in the upper portion of the opening and shutting door 4 and the engaging portion 11b disposed in the lower portion of the opening and shutting door 4 are removed from the door hook 13 simultaneously, the opening and shutting door 4 cannot be opened. Thus, since the opening and shutting door 4 cannot be opened even when only the engaging portion 11a or only the engaging portion 11b is removed from the door hook 13, the safety of the cooking apparatus can be enhanced. In the door key 11 base portion, there are opened up elongated holes 11d, 11e at two or more positions along the longitudinal direction of the door key 11. When pins 4b, 4c fixedly mounted on the opening and shutting door 4 side are inserted into these elongated holes 11d, 11e, the pins 4b, 4c are allowed to move on the vertical track along the elongated holes 11d, 11e of the door key 11. By the way, the elongated holes 11d, 11e may be formed in the opening and shutting door 4 instead of the door key 11. In this case, the pins 4b, 4c are provided on the door key 11. Also, in the door key 11, there are formed teeth (rack) 11c which can be meshingly engaged with the pinion 5a formed in the other end portion of the handle 5. The door key 11 is energized upwardly by a spring 17. By the way, depending on the position (specifically, the position in the longitudinal direction) of the door key where the rack and pinion are meshingly engaged with each other, the mounting position of the handle, namely, the mounting position of a knob for opening and shutting the door outside the opening and shutting door can be decided freely. In other words, the rack may be disposed at a position where the rack faces the pinion of the handle disposed at a desired position. Also, there may also be employed a structure in which a rack is formed along the entire length of the door key and the rack can be meshingly engaged with the pinion at any position, thereby enhancing the versatility of the door key.

The door hook 13 includes, at the positions of the insertion openings 12a, 12b of the main body case 2, insertion openings 13c, 13d into which the engaging portions 11a, 11b can be inserted when shutting the opening and shutting door 4 as well as guide portions 13a, 13b which are extended obliquely downward from upwardly of the insertion openings 13c, 13d into the door hook 13 and are used to guide the insertion operation of the door key 11. Also, within the door hook 13, there are provided door switches 14-16.

The door switches 14-16 are used to detect whether the opening and shutting door 4 is shut or not. And, although the details of the door switches 14-16 will be described later, when the opening and shutting door 4 is shut, they complete a circuit (which is hereinafter referred to as a power supply circuit) connected to a power supply part (not shown) for driving a magnetron to thereby generate microwaves and a control part (not shown) for controlling the power supply part, thereby allowing the power supply part to operate; and, when the opening and shutting door 4 is opened, they break the connection of the power supply circuit. The door switches 14-16 respectively include operation portions 14a-16a which, when depressed, switch the on/off of the switches. The door switch 14 is a latch switch, the door switch 15 is a short switch, and the door switch 16 is a door signal switch. Here, the operation portion 14a and guide portion 13a are arranged in such a manner that the operation portion 14a cannot be operated directly from any portion of the insertion portion 12a, for example, even when a foreign object such as a finger or a club is inserted. This also applies similarly to the position arrangement of the insertion portion 12b with respect to the operation portion 16a and guide portion 13b. This can guarantee the operations of the door switches 14 and 16.

In a state shown in FIG. 2 where the opening and shutting door 4 is shut, the door key 11 is inserted into the door hook 13 and, in a state where the operation portions 14a-16a of the door switches 14-16 are depressed, the door key is held by the door hook 13. When opening the opening and shutting door 4 from this state, the handle 5 may be pulled toward this side, whereby the handle 5 is rotated about a fulcrum 5b and the rotation force of the handle 5 is converted to a downward going force by the pinion 5a and rack 11c and is then transmitted to the door key 11. The door key 11 is pressed down by the downward going force and, as shown in FIG. 3, engagement between the engagement portions 11a, 11b and guide portions 13a, 13b is removed. In this state, when the handle 5 is pulled in the horizontal direction in FIG. 2, the opening and shutting door 4 is opened. Since the door key 11 and handle 5 are arranged on the opening and shutting door 4, when compared with a structure in which they are arranged in different portions as in the prior art, there is no fear that the door key 11 and handle 5 can be shifted in position from each other.

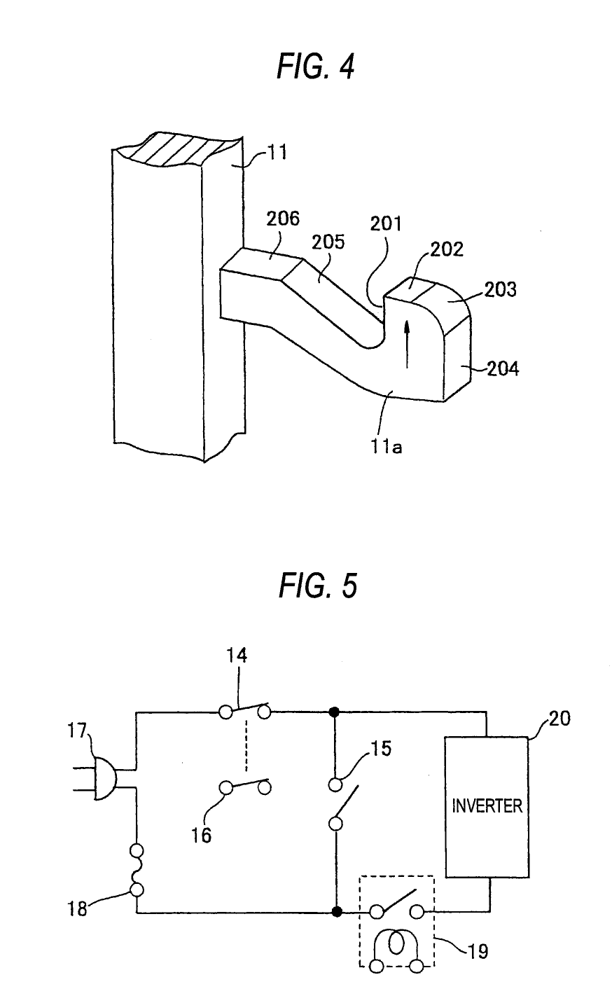

Next, description will be given below of the shapes of the engaging portions 11a and 11b of the door key 11 with reference to FIG. 4. FIG. 4 is an enlarged view of the engaging portion 11a. In the engaging portion 11a, the upper surface thereof is composed of a horizontal portion 206, a oblique side portion 205, a vertical portion 201, a horizontal portion 202 and a curved surface portion 203 sequentially in this order from the door key 11 main body side; and, this upper surface is connected to the lower surface of the engaging portion 11a through a vertical side wall 204. The oblique side portion 205 and vertical portion 201 cooperate together in forming a substantially V-like shape. When shutting the opening and shutting door 4, the engaging portion 11a is inserted into the door hook 13 while the curved surface portion 203 is slidingly contacted with the guide portion 13a (see FIGS. 2 and 3) and, after then, the engaging portion 11a is pushed further in the horizontal direction while the horizontal portion 202 is slidingly contacted with the end portion of the guide portion 13a. And, while the vertical portion 201 is slidingly contacted with the end portion of the guide portion 13a, the engaging portion 11a is moved in the upward direction due to the restoring force of the spring 17 and, in a state where the oblique side portion 205 is in contact with the lower surface of the guide portion 13a, the engaging portion 11a is held by the door hook 13. In this case, since the sliding direction of the vertical portion 201 is the same as the direction (in FIG. 4, the direction of an arrow mark) of the restoring force of the spring 17, resistance caused by the sliding contact between the vertical portion 201 and the end portion of the guide portion 13a is extremely small. Thanks to this, the door switches 14, 16 can be operated positively. By the way, the shape and operation of the engaging portion 11b are similar to the engaging portion 11a. According to this structure, the door key 11 and door hook 13 can be held in such a manner that there is generated no clearance between the vertical portion 201 of the engaging portion 11a (which also applies similarly to the engaging portion 11b) and the terminal end portion of the guide portion 13a. Therefore, in a state where the opening and shutting door 4 is shut, a clearance is difficult to occur between the opening and shutting door 4 and main body case 2. Also, in the door key 11, the leading end portions of the engaging portions 11a and 11b are projected upwardly. Further, in correspondence to the projecting direction of the leading end portions of these engaging portions 11a and 11b , the operation portions 14a and 16a of the door switches 14 and 16 are arranged in the lower portions of these switches. This structure makes it difficult for a foreign object to stick to the leading end portions of the engaging portions 11a and 11b. This not only can prevent generation of a time lag in the timings for depressing the door switches 14 and 16 but also can prevent the operation failures of the door switches 14 and 16. Also, since this structure not only can prevent a foreign object such as meat soup or other liquid soup from moving from the door key 11 side into the respective operation portions 14a and 16a of the door switches 14 and 16 but also can prevent a foreign object or dust from sticking to the respective operation portions 14a and 16a, the door switches 14 and 16 can be prevented against operation failures and thus can be operated positively.

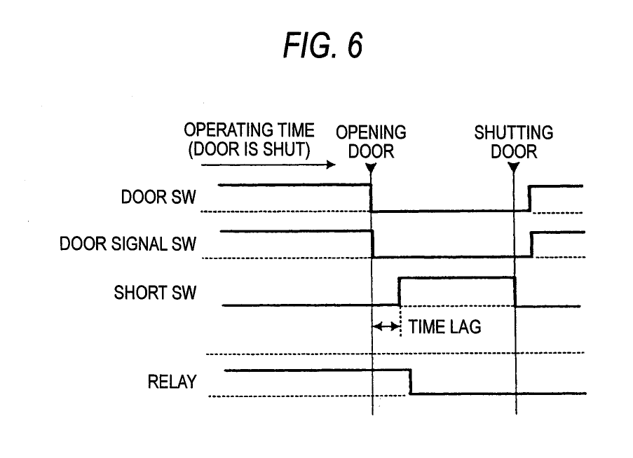

Here, description will be given below in detail of the electric operation of the power supply circuit including the door switches 14-16 with reference to FIGS. 5 and 6. FIG. 5 shows an example of a circuit diagram of the power supply circuit and FIG. 6 shows an example of the timing charts of the respective switches when opening and shutting the opening and shutting door. The door switches 14 and 16, when their operation portions 14a and 16a are depressed, are turned on respectively; and, the door switch 15 is turned off when its operation portion 15a is depressed. The door switch 14 is arranged in the vicinity of the terminal end portion of the guide portion 13a, more specifically, at a position where, in a state in which the door key 11 is held by the door hook 13 (in a state in which the opening and shutting door 4 is shut), the operation portion 14a is contacted with the horizontal portion 202 providing the upper surface of the leading end portion of the engaging portion 11a. The door switch 15 is arranged in the vicinity of the terminal end portion of the guide portion 13a, more specifically, at a position where, in a state in which the door key 11 is held by the door hook 13, the operation portion 15a is contacted with the vertical side wall 204 providing the leading end face of the engaging portion 11a. The door switch 16 is arranged in the vicinity of the terminal end portion of the guide portion 13b, more specifically, at a position where, in a state in which the door key 11 is held by the door hook 13, the operation portion 16a is contacted with the upper surface of the leading end portion of the engaging portion 11b. In the power supply circuit shown in FIG. 5, the door switches 14, 15 and a fuse 18 are respectively connected in series to a commercial power supply 17, while a relay 19 to be turned on or off in linking with the on or off of the door switch 16 and an inverter 20 connected in series to the relay are connected in parallel to the door switch 15. The fuse 18 is used to cut off this circuit when both of the door switch 14 and door switch (short switch) 15 are turned on. The inverter 20 is used to increase the voltage (for example, 100V) of the commercial power supply 17 up to a voltage (for example, several kV) necessary to drive the magnetron. That is, when a current flows in the inverter 20, the microwaves can be generated.

As shown in FIG. 6, in a state where the opening and shutting door 4 is shut, the door switches 14, 16 are on and the door switch (short switch) 15 is off. Therefore, in this state, a current flows from the commercial power supply 17 to the inverter 20, thereby being able to oscillate the magnetron. When opening the opening and shutting door 4 from this state, as described above, firstly, the door switch 14 is turned off and, after then, with the passage of a given time (a time lag), the door switch (short switch) 15 is turned on. This makes it possible to operate the power supply circuit more safely.

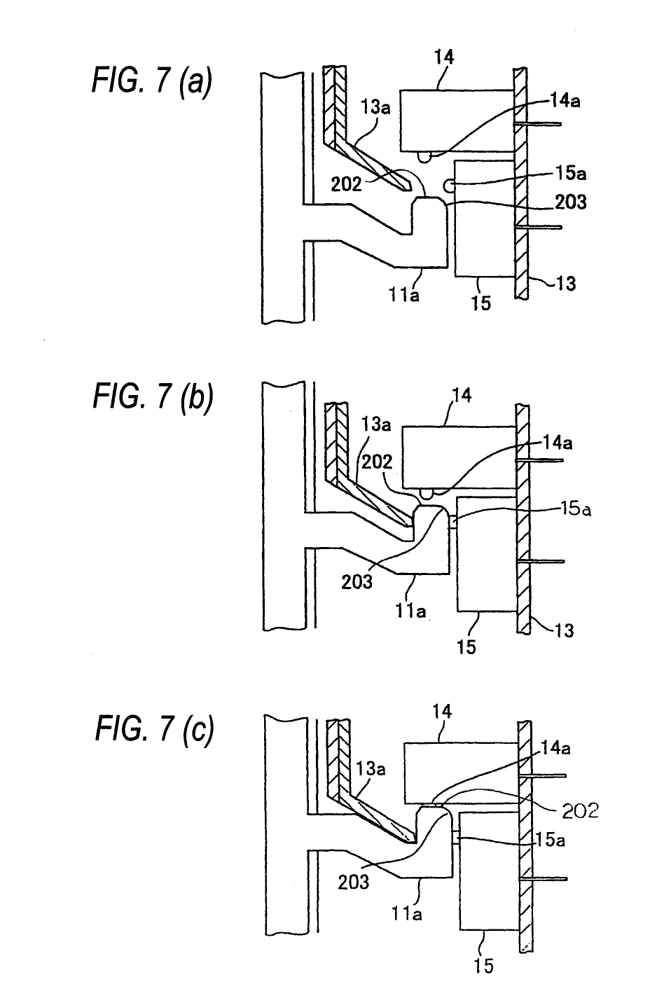

Next, description will be given below of the operation of the engaging portion 11a to depress the operation portions 14a, 15a when shutting the opening and shutting door 4 with reference to FIG. 7. FIG. 7 is an enlarged section view of the engaging portion 11a and door switches 14, 15. Specifically, FIG. 7A shows a state in which none of the operation portions are depressed, FIG. 7B shows a state in which one of the operation portions is depressed, and FIG. 7C shows a state in which both of the operation portions are depressed, respectively. When the engaged portion 11a (see FIG. 7A), which is guided by the guide portion 13a and is inserted into the door hook 13 and, after then, is pushed in the horizontal direction, is moved in the upward direction, the curved surface portion 203 depresses the operation portion 15a (see FIG. 7B). And, the horizontal portion 22 presses down the operation portion 14a, while the engaging portion I1 a is held by the door hook 13 at a position where it is regulated by the door switches 14, 15 and guide portion 13a (see FIG. 7C). That is, as for the door switches 14 and 15, after the door switch 15 serving as a short switch is turned off, the door switch 14 serving as a latch switch is turned on. On the other hand, when opening the opening and shutting door 4, after the door switch 14 is turned off, the short switch 15 is turned on. Thanks to this, the power supply circuit can be operated more safely. By the way, as for the door switch 16, simultaneously when the on and off of the door switch 14 are switched over to each other, the on and off of the door switch 16 are switched. This is not only because the engaging portions 11a and 11b are both part of the door key 11 but also because, in a state where the door key 11 is held by the door hook 13, the position relationship between the door switch 16 and engaging portion 13b is the same as the position relationship between the door switch 14 and engaging portion 13a. Thanks to this structure, the opening and shutting door 4 is difficult to be shut in an incomplete state where, for example, the upper portion of the opening and shutting door 4 is shut but the lower portion thereof is opened, and, therefore, the safety of the high frequency cooking apparatus 1 can be enhanced.

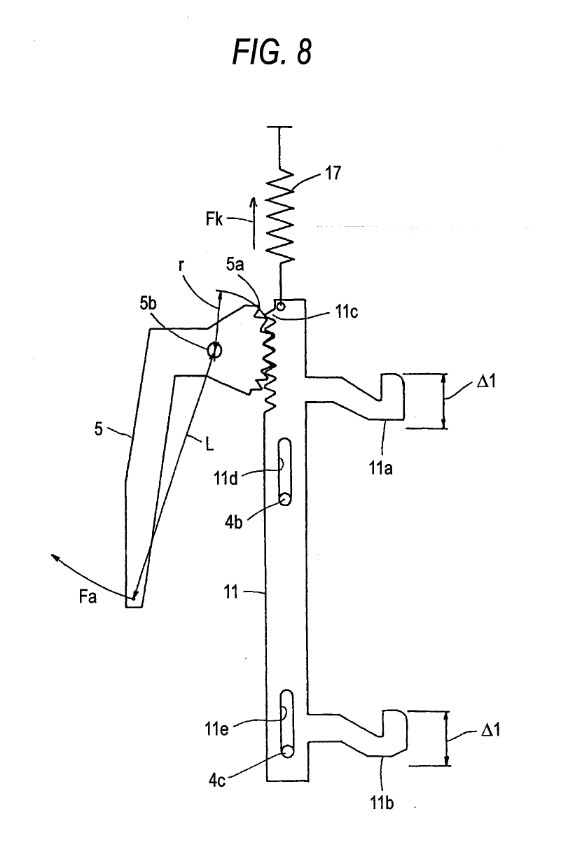

Next, description will be given below of a mechanical structure employed in the first embodiment with reference to FIG. 8. As shown in FIG. 8, where the length of the handle 5 is expressed as L, a radius from the fulcrum of the handle 5 to the pinion 5a is expressed as r, the tensile force of the spring 17 is expressed as Fk, the spring constant of the spring 17 is expressed as k, the stroke of each of the engaging portions 11a and 11b is expressed as Δl and a force necessary to lift the handle 5 is expressed as Fa, there can be provided the following numerical equation [1]. That is:
Fa=r/L Fk, Fk=kΔl; thus, Fa=r/L kΔl.

With employment of this structure, even when there is used the spring 17 having a large spring constant in order to increase the engaging forces of the engaging portions 11a and 11b of the door key 11 with respect to the door hook 13 for positive engagement, the force necessary to lift the handle 5 can be reduced. In other words, the handle 5 can be operated with a small force and also use of the spring 17 having a large force makes it possible to lock the opening and shutting door 4 positively.

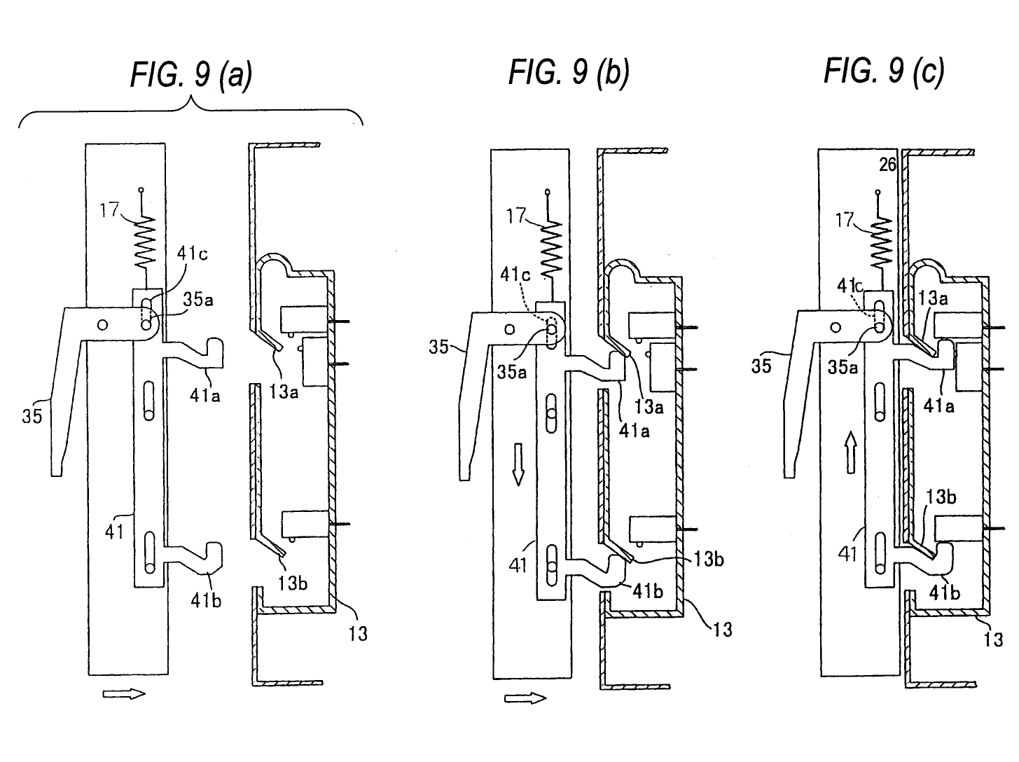

Description has been given heretofore of an example in which the door key 11 and handle 5 can be cooperatively structured due to the mutual meshing engagement between the rack 11c and pinion 5a. However, the connecting portion between the door key and handle may also have other structures. Here, FIG. 9 is a section view of the connecting portion between the door key and handle having another structure. Specifically, FIG. 9A shows a state where the opening and shutting door is opened, FIG. 9B shows a state where the door key is in part inserted into the main body side, and FIG. 9C shows a state where the opening and shutting door is shut, respectively. A handle 35 is substantially the same as the handle 5 in structure but it includes a pin 35a instead of the pinion 5a. Also, the door key 41 is substantially the same as the door key 11 in structure but, in the vicinity of the upper end portion of the door key 41, instead of the rack 11c, there is opened up an elongated hole 41c which extends along the longitudinal direction of the door key 41 and is used for an idling operation. When the pin 35a is inserted into the elongated hole 41c, the handle 35 is connected to the door key 41. As a result of this, the door key 41 and handle 35 can be operated in linking with each other. According to this structure, when shutting the opening and shutting door 4, as shown in FIG. 9B, the engaging portions 41a and 41b of the door key 41 are guided by the guide portions 13a and 13b and the door key 41 is shifted downwardly, whereas the pin 35a is shifted upwardly within the elongated hole 41c; and, therefore, without the handle 35 being shifted, the door key 41 is held by the door hook 13 (see FIG. 9C). That is, when shutting the opening and shutting door 4, the handle 35 is prevented from being lifted up toward this side.

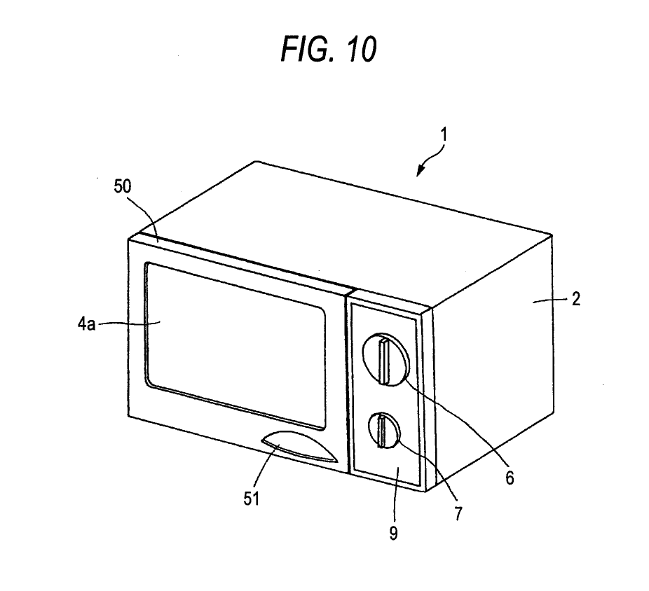

Next, description will be given below of a second embodiment of a door opening and shutting part according to the invention with reference to FIGS. 10-12. By the way, the same parts or equivalent parts to the first embodiment are given the same designations and thus the description thereof is omitted or simplified here.

As shown in FIG. 10, an opening and shutting door 50 constituting a door opening and shutting part of a cooking apparatus according to the present embodiment is characterized in that it can be opened by pulling a handle 51, which is provided in the lower portion of the right end portion of the door 50, toward this side (obliquely upwardly), and also that, when shutting the door 50, the handle 51 is prevented from floating up. When compared with the first embodiment, the handle 51 and door key 52 are different in structure. The handle 51 is formed in arc-like projecting shape and is structured such that a hand can be inserted into the inside thereof; and, by pulling the handle 51 toward this side, the opening and shutting door 50 can be opened.

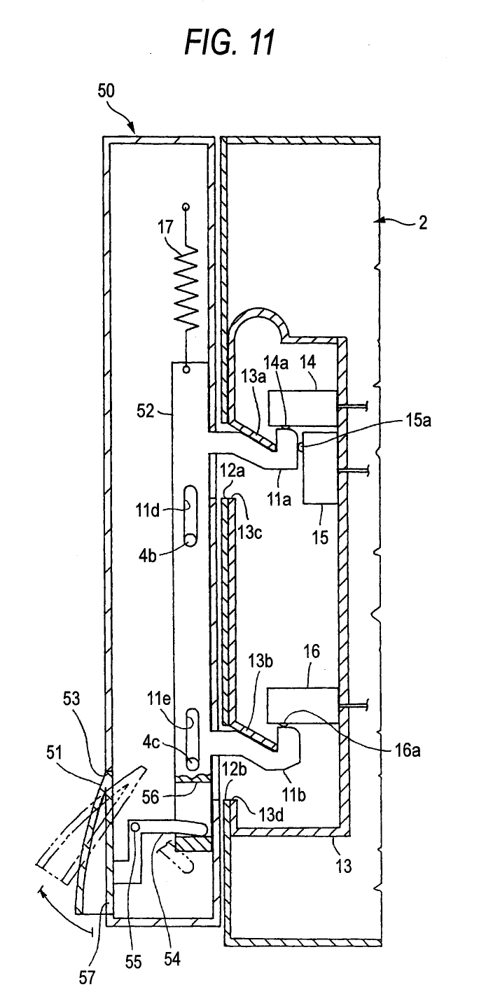

As shown in FIG. 11, the handle 51 is disposed within an opening 53 formed in the lower portion of the right end portion of the opening and shutting door 50 and includes on the back surface thereof an arm 54 projected in a crank shape. Since the central portion of the arm 54 is formed as a fulcrum 55 supported by the opening and shutting door 50, when it is pulled up, it is rotated with respect to the opening and shutting door 50. The leading end portion of the arm 54 is formed to have a small thickness.

In the door key 52, downwardly of a lower engaging portion 11b of a pair of engaging portions 11a and 11b, an elongated-hole-shaped cut-out hole 56 which is used for driving and idling operations. The cut-out hole 56 penetrates from the front surface side of the opening and shutting door 50 to the door hook 13 side, while the leading end portion of the arm 54 of the handle 51 is loosely inserted into the cut-out hole 56.

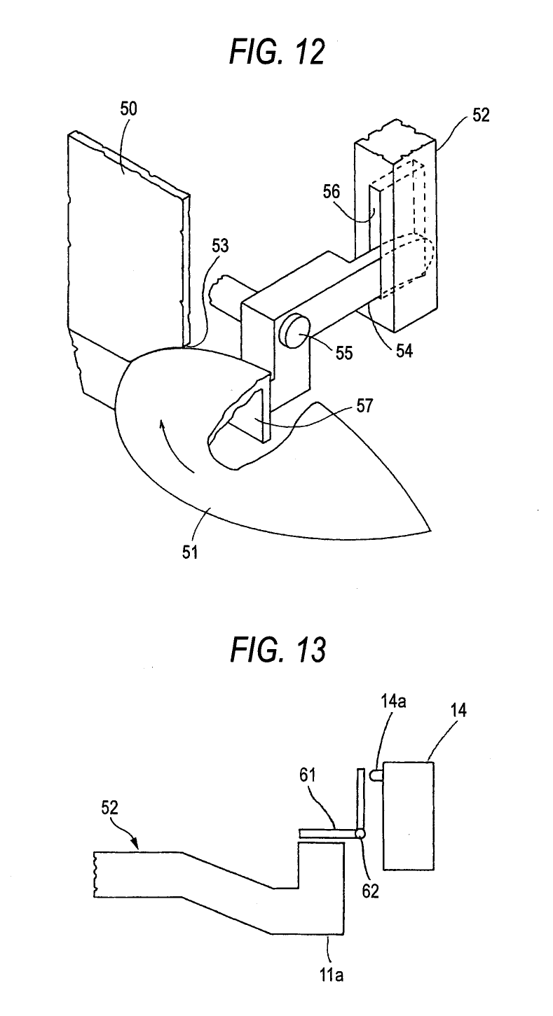

As shown in FIG. 12, the base end portion of the arm 54 is connected to the substantially central portion of the rear plate 57 of the handle 51, while the leading end portion of the arm 54 projected through the fulcrum 55 is inserted into the cut-out hole 56 of the door key 52. The handle 51 and arm 54 may be preferably integrally formed of polymeric material such as plastics.

When opening the thus structured opening and shutting door 50, in a state where the opening and shutting door 50 is shut, the handle 51 may be pulled up. That is, when the handle 51 is pulled up, the arm 54 is pressed against the lower end portion of the door key 52 within the cut-out hole 56. As a result of this, the door key 52 is sided downward against the spring 17 and the engaging portions 11a, 11b are thereby removed from the guide portions 13a, 13b of the door hook 13 respectively. And, by pulling the handle toward this side, the opening and shutting door 50 is opened. When the opening and shutting door 50 is opened, the door key 52 is returned upwardly due to the elastic restoring force of the spring 17 and thus the arm 54, the lower end portion of which is in contact with the door key 52 within the cut-out hole 56, is rotated back to thereby return the handle 51 to the shut position (see FIG. 11).

And, when the opening and shutting door 50 is shut from this state, the engaging portions 11a and 11b move beyond the guide portions 13a and 13b of the door hook 13 and are then engaged with the guide portions 13a and 13b respectively. In this operation, the movements of the engaging portions 11a and 11b beyond the guide portions 13a and 13b cause the door key 11 to slide downwardly; however, the arm 54 of the handle 51 is only moved within the cut-out hole 56 of the door key 52 and thus the handle 51 is not pushed in a direction where it is lifted up, whereby the handle 51 can be held at the shut position.

As described above, in the opening and shutting door 50 of a door opening and shutting part of a cooking apparatus according to the present embodiment, the handle 51 includes the arm 54 for moving the door key 52, and the door key 52 includes the cut-out hole 56 which, when shutting the opening and shutting door 50, carries out an idling operation with respect to the arm 54 of the handle 51 held at the shut position. Thanks to this, when shutting the opening and shutting door 50, although the door key 52 is moved, the door key 52 is not pressed against the arm 54 but executes an idling operation to thereby be able to shut the opening and shutting door 50 while the handle 51 is not moved but remains at the shut position.

Also, in the opening and shutting door 50 of a door opening and shutting part of a cooking apparatus according to the present embodiment, as the handle 51 is operated, the engaging portions 11a and 11b are moved at the same time and thus, when shutting the opening and shutting door 50, the door switches 14 and 16 can be switched at the same time. Further, because the leading end portions of the engaging portions 11a and 11b of the door key 52 are projected upwardly, a foreign object such as meat soup or water drops is difficult to stick to the engaging portions 11a and 11b of the door key 52. This not only can prevent generation of a time lag in the operation timings when the door switches 14 and 16 are depressed but also can prevent the operation failures of the door switches 14 and 16. Therefore, the opening and shutting door 50 is prevented from being shut incompletely, thereby being able to enhance the safety of the cooking apparatus 1. Also, since the opening and shutting door 50 can be opened and shut by operating the handle 51, that is, since the opening and shutting operation of the opening and shutting door 50 can be carried out easily, the efficiency of the door opening and shutting operation can be enhanced. And, since the door switches 14 and 16 can be operated positively, the quality of a cooked food can be enhanced.

Also, in the opening and shutting door 50 of a door opening and shutting part of a cooking apparatus according to the present embodiment, since the operation portions 14a and 16a of the door switches 14 and 16 are disposed in the lower portions of the door switches 14 and 16, not only a foreign object such meat soup or water drops is prevented from moving from the door key 52 side into the respective operation portions 14a and 16a, but also a foreign object, dust and the like are prevented from sticking to the operation portions 14a and 16b. This can prevent the operation failures of the door switches 14 and 16 and thus the door switches 14 and 16 can be operated positively.

Also, in the opening and shutting door 50 of a door opening and shutting part of a cooking apparatus according to the present embodiment, since the relative position of the door switch 14 to the engaging portion 16a, in the shut state of the opening and shutting door 50, is the same as the relative position of the door switch 16 to the engaging portion 16b, when the handle 51 is operated, the engaging portions 11a and 11b are operated simultaneously. And, in a state where the opening and shutting door 50 shuts the object-to-be-heated take-out opening, since the relative positions between the engaging portions 11a, 11b and door switches 14, 16 are the same, when shutting the opening and shutting door 50, the door switches 14 and 16 can be switched simultaneously. This makes it difficult for the opening and shutting door 50 to be shut incompletely, thereby being able to enhance the safety of the cooking apparatus 1. And, by opening and shutting the opening and shutting door 50 through the operation of the handle 51, the opening and shutting door 50 can be easily opened and shut with a small force. This can enhance the efficiency of the operation to be executed when opening and shutting the opening and shutting door.

Also, in the opening and shutting door 50 of a door opening and shutting part of a cooking apparatus according to the present embodiment, the engaging portions 11a and 11b of the door key 52 respectively include portions which are parallel to the door key 52; and, the door hook 13, in the shut state, holds the door key 52 in such a manner that the parallel portions of the engaging portions 11a and 11b are contacted with the door hook 13. Thanks to this, in the shut state, the door hook 13 can hold the door key 52 without generating a clearance between itself and engaging portions 11a, 11b. Therefore, the opening and shutting door 50 can shut the object-to-be-heated take-out opening without generating a clearance between the cooking apparatus main body and itself.

Also, in the opening and shutting door 50 of a door opening and shutting part of a cooking apparatus according to the present embodiment, the door hook 13 includes, in the vicinity of the door switch 14, the short switch 15 which, when the engaging portion 11a is held, can be switched so as to allow the power supply circuit to conduct. And, the engaging portion 11a is structured such that, when the opening and shutting door 50 shuts the object-to-be-heated take-out opening, presses down the door switch 14 after it presses down the short switch 15. Thanks to this, the power supply circuit can be operated more safely.

Next, description will be given below of a modification of the structure for combining the door key 52 with the door switches 14, 15, 16 with reference to FIG. 13.

As shown in FIG. 13, between the leading end portion of the engaging portion 11a of the door key 52 and the operation portion 14a of the door switch 14, there is interposed a movable piece 61 formed in a thin plate shape and having an L-like section shape. The door switch 14 side of the movable piece 61 is used as the rotation center 62 thereof and thus the movable piece 61 can be rotated about this rotation center 62.

According to this modification, when the door key 52 is slidingly moved downwardly by lifting up the handle 51 (see FIG. 10), the engaging portion 11a is removed from one end portion of the movable piece 61, whereby the other end portion of the movable piece 61 is prevented from depressing the operation portion 14a of the door switch 14. On the other hand, when the door key 52 is moved downwardly and is then returned upwardly by shutting the opening and shutting door, the engaging portion 11a presses one end portion of the movable piece 61, whereby the other end portion of the movable piece 61 presses down the operation portion 14a of the door switch 14 to thereby turn on the door switch 14. In this case, since the movable piece 61 includes the rotation center 62 arranged on the door switch 14 side, there is secured a large space upwardly of the left side of the engaging portion 11a, movable piece 61 and door switch 14, so that this space can be used effectively and thus the freedom of design of the layout can be enhanced. By the way, even when the movable piece 61 is interposed between the leading end portion of the engaging portion 11a of the door key 52 and the operation portion 15a of the door switch 15 or between the leading end portion of the engaging portion 11b of the door key 52 and the operation portion 16a of the door switch 16, the movable piece 62 can provide a similar operation effect to the above arrangement. Also, the movable piece 61 may be integrally connected to the operation portion 14a of the door switch 14.

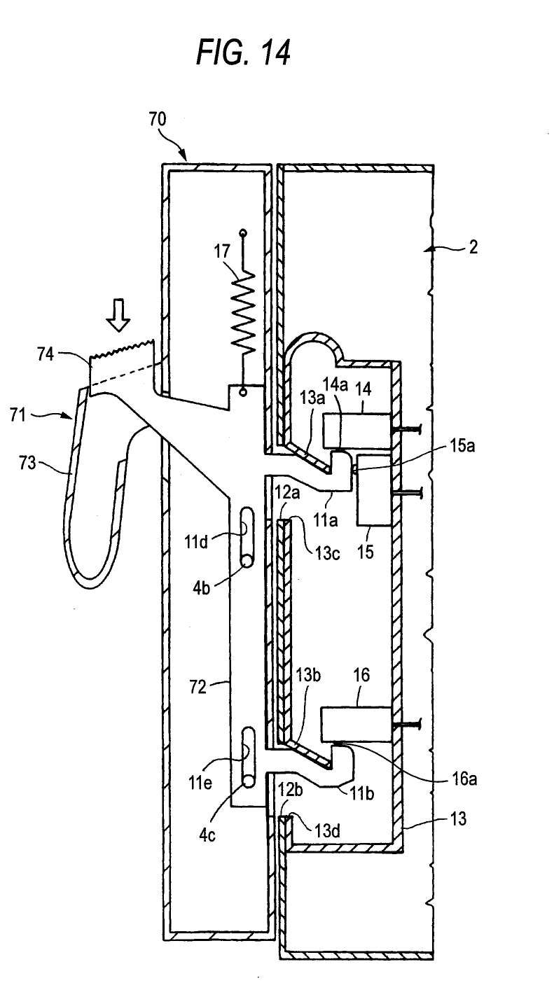

Next, description will be given below of a third embodiment of a door opening and shutting part according to the invention with reference to FIG. 14. By the way, the same parts or equivalent parts to the first embodiment are given the same designations and thus the description thereof is omitted or simplified here.

As shown in FIG. 14, an opening and shutting door 70 constituting a door opening and shutting part of a cooking apparatus according to the third embodiment of the invention is characterized in that a handle 71 and a door key 72 are formed as an integral body. In this case, the handle 71 includes a lower handle 73 and a movable portion 74, while the lower handle 73 is formed integrally with the opening and shutting door 70 and the movable part 74 is formed integrally with the door key 72.

In the opening and shutting door 70, when the lower handle 73 is gripped with a hand and the movable part 74 is pressed in a push-button manner, the door key 72 is slided downward against the spring 17 and thus the respective engaging portions 11a, 11b are removed from their associated guide portions 13a, 13b of the door hook 13. And, by pulling the lower handle 73 toward this side, the opening and shutting door 70 can be opened. When the opening and shutting door 70 is opened, the door key 72 is returned upwardly due to the restoring force of the spring 17, whereby the door key 72 is returned back to its shut position.

In the opening and shutting door 70 constituting a door opening and shutting part of a cooking apparatus according to the present embodiment, because the opening and shutting door 70 can be opened and shut while the handle 71 is gripped with a hand, a stable opening and shutting operation can be executed. By the way, the handle 71 may also be disposed near to the upper portion of the opening and shutting door 70 or near to the lower portion of the opening and shutting door 70, instead of the central portion of the opening and shutting door 70 shown in FIG. 14.

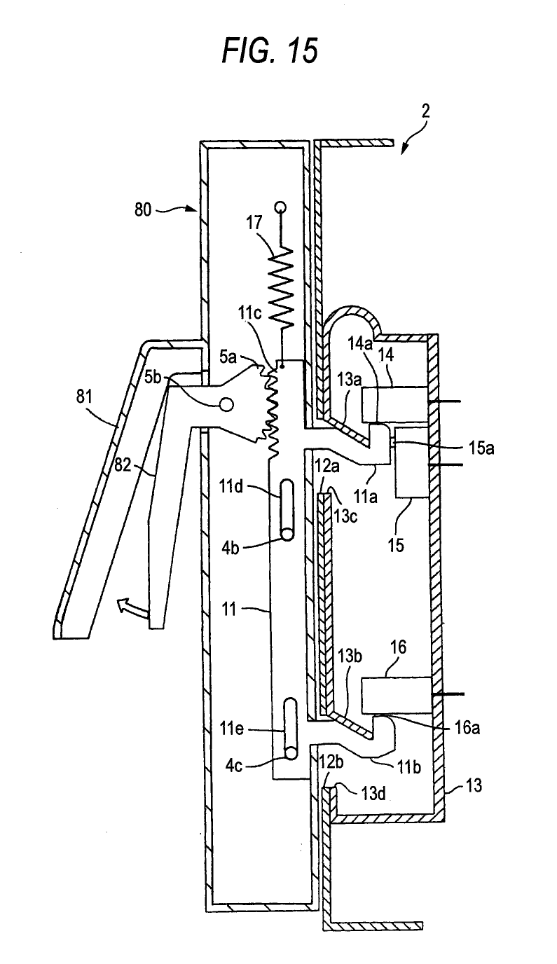

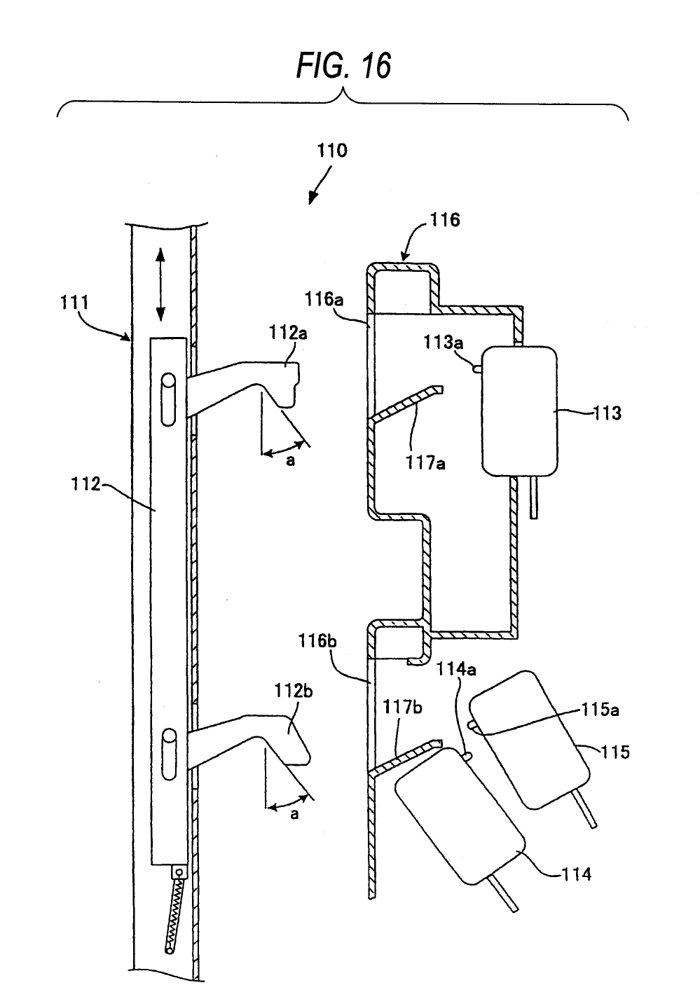

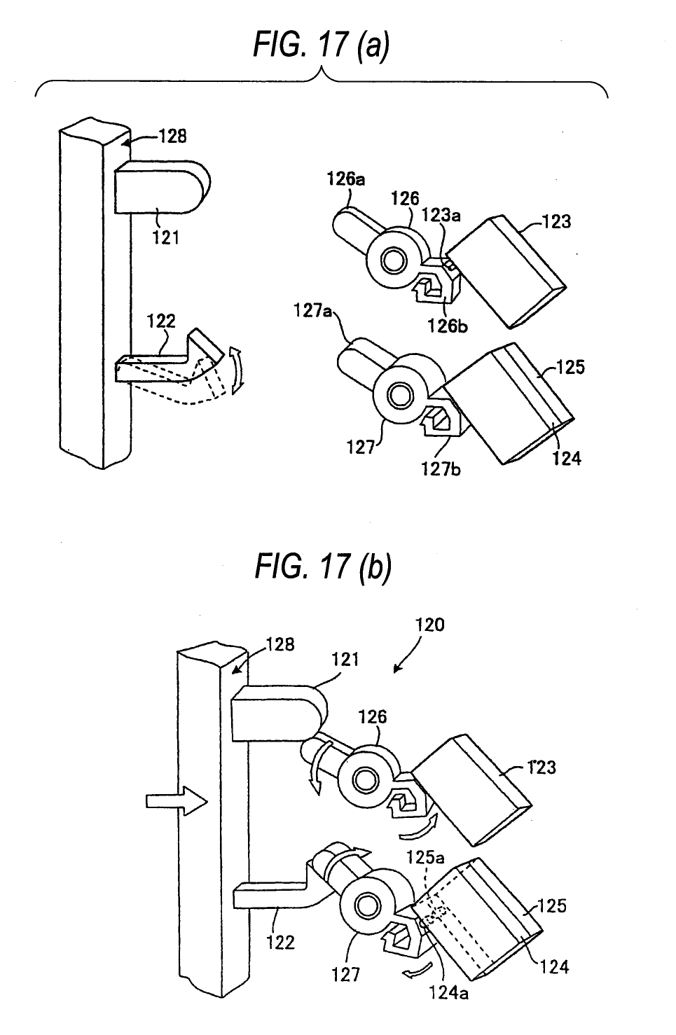

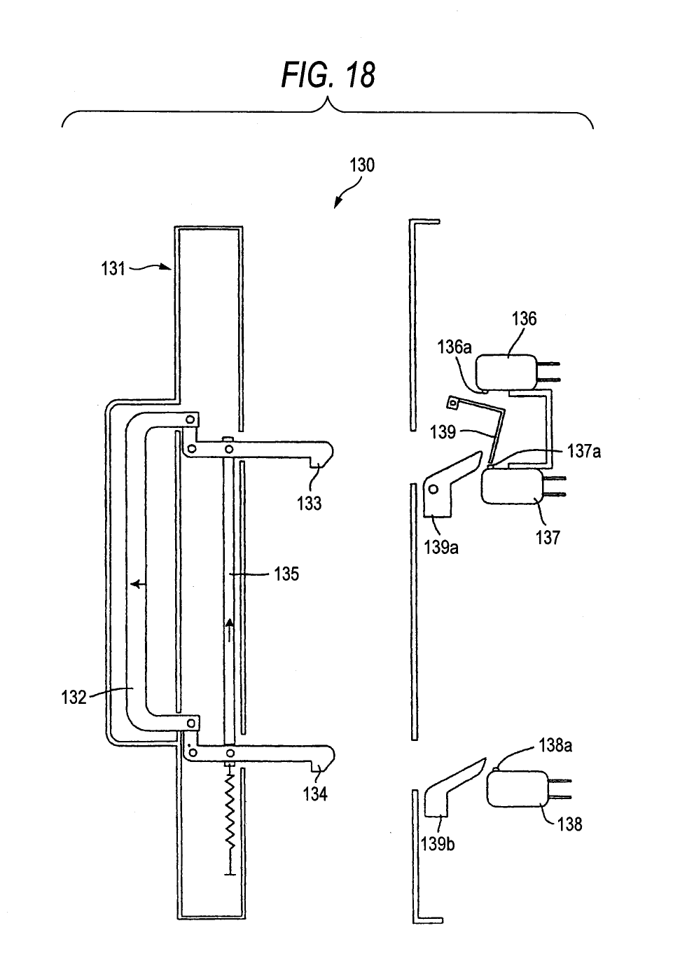

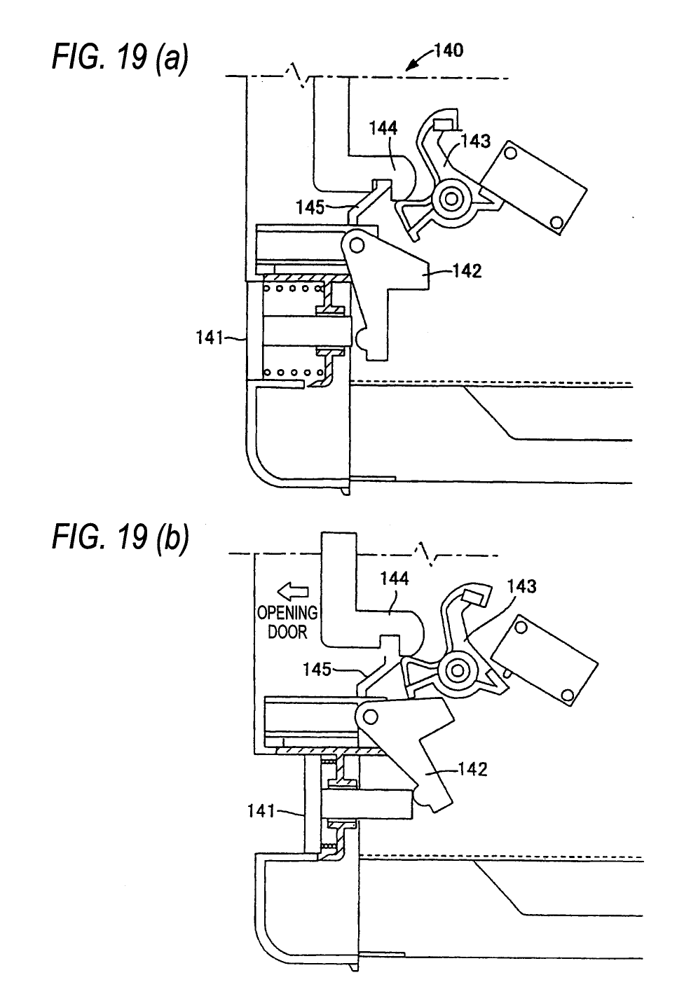

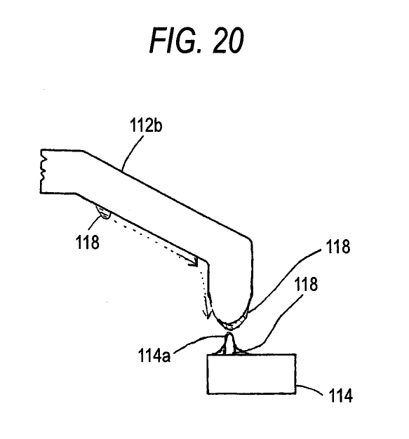

Next, description will be given below of a fourth embodiment according to the invention with reference to FIG. 15. By the way, the same parts or equivalent parts to the first embodiment are given the same designations and thus the description thereof is omitted or simplified here.

As shown in FIG. 15, an opening and shutting door 80 constituting a door opening and shutting part of a cooking apparatus according to the fourth embodiment is characterized in that, inside a fixed-side upper handle 81 formed integrally with the opening and shutting door 80, there is disposed a movable-side lower handle 82. In this case, the lower handle 82 functions as a handle (see FIG. 2) and, in the other end of the lower handle 82, there is provided a pinion 5a. The lower handle 82 is covered with the upper handle 81.

In the opening and shutting door 80, when the upper handle 81 and lower handle 82 are pulled toward this side while they are being gripped with a hand, the door key 11 is slided downward against the spring 17 and thus the respective engaging portions 11a, 11b are removed from their associated guide portions 13a, 13b of the door hook 13, whereby the opening and shutting door 80 can be opened. When the opening and shutting door 80 is opened, the door key 13 is moved back upwardly due to the restoring force of the spring 17, so that the door key 13 is returned to its shut position.

In the opening and shutting door 80 constituting a door opening and shutting part of a cooking apparatus according to the present embodiment, because the opening and shutting door 80 can be opened with the upper and lower handles 81 and 82 gripped with a hand, a positive opening and shutting operation can be carried out.

As has been described heretofore, with use of the door opening and shutting parts of a cooking apparatus according to the respective embodiments of the invention, the safety of a high frequency cooking apparatus, the efficiency of the door opening and shutting operation, and the quality of a cooked food can be enhanced.

Although description has been given heretofore of the invention with reference to a high frequency cooking apparatus which generates microwaves, the invention can also apply to a door opening and shutting part for a cooking apparatus such as an oven and a grill cooking apparatus.

Although description has been given heretofore of the invention in detail as well as with reference to the specific embodiments thereof, it is obvious to those skilled in the art that various changes and modifications are also possible without departing from the spirit and scope of the invention.

The present application is based on the Japanese patent application No. 2004-062662 filed on Mar. 5, 2004 and the contents thereof are incorporated herein as reference.

### INDUSTRIAL APPLICABILITY

A door opening and shutting part of a cooking apparatus according to the invention can provide effects that the safety of a cooking apparatus, the efficiency of the door opening and shutting operation and the quality of a cooked food can be improved. Therefore, the invention is useful for a door opening and shutting part of, for example, a microwave oven and an oven.

1. A cooking apparatus, comprising:
a cooking apparatus main body that includes a heating chamber; and
a door opening and shutting part that openably and closably locks the object-to-be-heated take-out opening of the heating chamber to shut the take-out opening, and removes the locked state of the take-out opening to open the take-out opening,
wherein the door opening and shutting part includes:
a handle which opens and shuts an opening and shutting door; and
a door key which is provided on the opening and shutting door so as to be movable in the longitudinal direction thereof in conjunction with an opening and shutting operation of the handle, and is integrally formed with first and second engaging portions, the first and second engaging portions respectively being provided on the two portions of the door key spaced a predetermined distance from each other in the longitudinal direction of the door key so as to project toward the heating chamber;
wherein the cooking apparatus main body includes a door hook which holds the door key by engaging with the first and second engaging portions, which are inserted into the cooking apparatus main body when the opening and shutting door is shut;
wherein the door hook includes first and second switches which respectively switch so as to electrically conduct a power supply circuit for heating the heating chamber by carrying out depressing operations of the first and second engaging portions when the door hook is engaged with the first and second engaging portions; and
wherein a play in a connecting portion between the handle and the door key is set as a distance which corresponds to a distance that the door key moves in the longitudinal direction thereof when the opening and shutting door is switched from an opened state to a shut state.

2. The cooking apparatus as set forth in claim 1, wherein the first and second engaging portions are disposed independently of each other in the upper and lower portions of the opening and shutting door.

3. The cooking apparatus as set forth in claim 1, wherein the leading end portions of the first and second engaging portions project upwardly.

4. The cooking apparatus as set forth in claim 1, wherein the first and second door switches are disposed so that pressing operation portions face downward.

5. The cooking apparatus as set forth in claim 1, wherein a position of the first door switch relative to the first engaging portion is the same as a position of the second switch relative to the second engaging portion in the shut state of the opening and shutting door.

6. The cooking apparatus as set forth in claim 1, wherein the door key includes parallel portions in the first and second engaging portions, which are parallel to the longitudinal direction of the door key; and
wherein the door hook brings the parallel portions into contact with the door hook to hold the door key in the shut state of the opening and shutting door.

7. The cooking apparatus as set forth in claim 1, wherein either one of the door hooks includes a short switch, in the vicinity of the first door switch, which is switched over so as to electrically conduct the power supply circuit when the first engaging portion is held; and
wherein the first engaging portion is disposed at a position where when shutting the opening and shutting door, the first engaging portion depresses the first door switch after the first engaging portion presses down the short switch.

8. The cooking apparatus as set forth in claim 1, wherein the handle is connected to the door key by a rack and pinion mechanism; and
wherein the door key is operated in a vertical direction in accordance with a rotation operation of the handle.
